(19) United States
(12) Patent Application Publication
(10) Pub. No.: US 2012/0035911 A1
(43) Pub. Date: Feb. 9, 2012

(54) CUSTOMER PREMISES EQUIPMENT AND CONFIGURATION METHOD THEREOF

(75) Inventor: JIUNN-JIA CHEN, Tu-Cheng (TW)

(73) Assignee: HON HAI PRECISION INDUSTRY CO., LTD., Tu-Cheng (TW)

(21) Appl. No.: 12/891,763

(22) Filed: Sep. 27, 2010

(30) Foreign Application Priority Data
Aug. 5, 2010 (CN) 201010246152.1

(51) Int. Cl. G06F 17/20

(52) U.S. Cl. 704/8

(57) ABSTRACT

A customer premises equipment accessible with electronic equipment. The electronic equipment has a browser. Many types of language environments are stored in the customer premises equipment. The customer premises equipment includes a language module, a matching module, and a setting module. The language module recognizes a language version of the browser. The matching module checks whether the language version of the browser is same as the language environment stored in the customer premises equipment or not. The setting module sets the language environment of the customer premises equipment the same as the language version of the browser. And the present disclosure also provides a configuration method for the customer premises equipment.

### BACKGROUND

1. Technical Field

The present disclosure relates to a customer premises equipment and a configuration method thereof.

2. Description of Related Art

In order to sell customer premises equipment (CPE) to many countries, the manufacturers usually pre-store multiple language environments in the CPE, and set a default language environment according to which country the CPE will be sold in. Yet, in a globalized world, a user may buy a CPE from a country of a different language. He then needs to set the language of the CPE to his native language by himself. In this case, the user must connect the CPE to a computer, access the user interface of the CPE with a browser of the computer, and select a language environment from the user interface. However, the language of the browser is usually the native language of the user and is different from the default language environment of the CPE. Thus, the foreign characters of the user interface of the CPE may appear as gibberish, even when the foreign characters are normally displayed, the user may not know how to set the language because he is unfamiliar with the foreign language.

What is needed, therefore, is a new customer premises equipment and a configuration method thereof to overcome the above-described problem.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments.

FIG. 1 is a block diagram of customer premises equipment, connected with an electronic device, according to an exemplary embodiment.

FIG. 2 is a WIFI-channel option mapping table for different countries stored in the customer premises equipment of FIG. 1.

FIG. 3 is a flowchart of a configuration method for the customer premises equipment of FIG. 1.

### DETAILED DESCRIPTION

Embodiments of the present disclosure will now be described in detail below, with reference to the accompanying drawings.

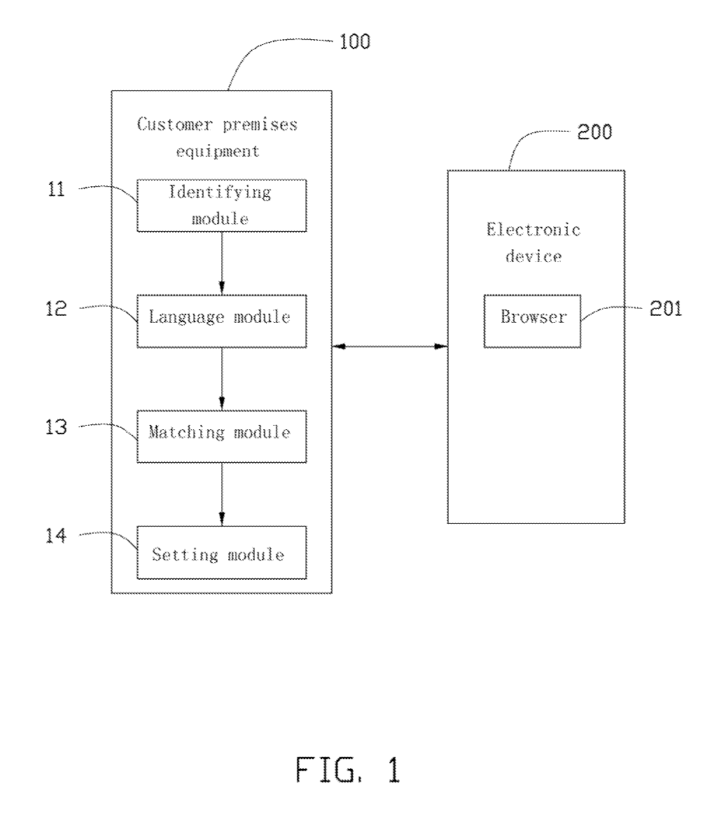

Referring to FIG. 1, a customer premises equipment (hereinafter “CPE”) 100, according to an exemplary embodiment, is connected to an electronic device 200. In the present embodiment, the CPE 100 is a router. The electronic device 200 is a personal computer. The CPE 100 is connected to the electronic device 200 with a cable. In other embodiments, the CPE 100 can be a network switch, the electronic device 200 can be a workstation or a portable device installing a browser 201, such as a hand-held computer or a smart phone, and the CPE 100 can communicate with the electronic device 200 by wireless technology.

The browser 201 is installed in the electronic device 200. The language version of the browser 201 is considered as the familiar language version for the user. In the present embodiment, the language environment of the CPE 100 is automatically set the same as that of the browser 201, and the configuration of the CPE 100 is automatically set to match the language setting of the browser 201.

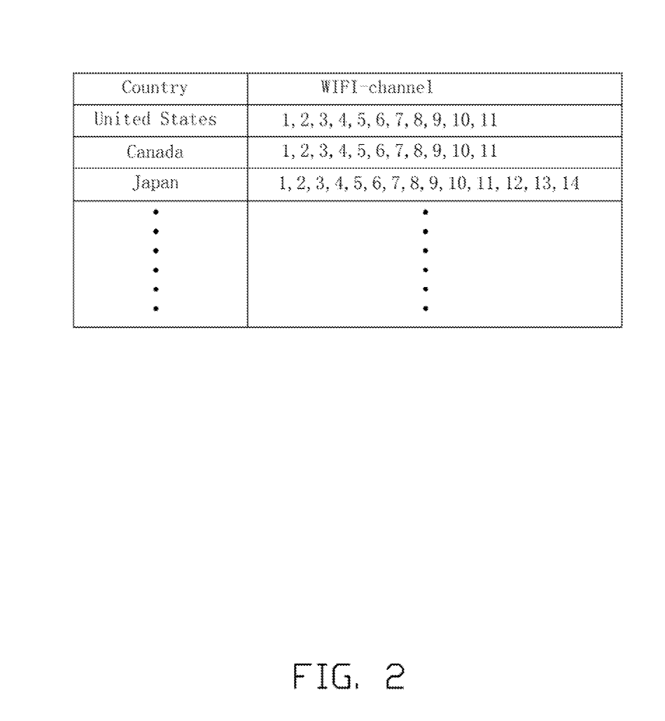

The CPE 100 pre-stores multiple language environments and the corresponding configuration parameters, such as WIFI-channel options and wimax frequencies. In the present embodiment, the CPE 100 pre-stores WIFI-channel options corresponding to different countries. The FIG. 2 is a mapping table that contains WIFI-channel options for different countries.

The CPE 100 stores a configuration web page showing the configuration parameters which can be changed by the user. The language of the configuration web page is the default language of the CPE 100. The configuration parameter is the default configuration corresponding to the default language of the CPE 100.

The CPE 100 includes an identifying module 11, a language module 12, a matching module 13, and a setting module 14. The identifying module 11 is used for identifying the type of browser 201 the electronic device 200 is using. The identifying module 11 sends a request to the electronic device 200 for checking what type of browser 201 is being used, using, for example, PHP language or JavaScript language, when the electronic device 200 accesses the CPE 100. The identifying module 11 identifies the type of browser 201 being used according to the responding message feedback from the browser 201. In the present embodiment, the identifying module 11 identifies the type of browser 201 being used, by sending a request to the electronic device 200 for checking the return value of the special function corresponding to the type of browser 201 being used by JavaScript language. For example, one of the ActiveXObject functions is to return a type value of the IE browser. The identifying module 11 sends a request to the electronic device 200 for checking the returned value of the ActiveXObject function. The identifying module 11 checks the value of the ActiveXObject function to check whether the browser 201 is an IE browser or not. In other embodiments, the identifying module 11 can also check the type of browser 201 by using a User Agent information of the browser 201. If the identifying module 11 is incapable of identifying the type of browser 201, the identifying module 11 will send a reminder message to the electronic device 200 to remind the user that the CPE 100 is incapable of identifying the browser 201.

The language module 12 is used for recognizing the language version of the browser 201. The language module 12 sends a request to the electronic device 200 for checking the language version of the browser 201. In the present embodiment, the language module 12 sends a request to the electronic device 200 to check the language version of the browser 201 using JavaScript language. The language module 12 can also use PHP language. For example, if the browser 201 is an IE browser, the language module 12 sends a request to the electronic device 200 to check the value of the navigator. Browserlanguage property to check the language code of the IE browser. If the return value is en-US, the language module 12 identifies the language version of the browser 201 is United States English. The language module 12 can also obtain the language version of other types of browsers by the same method.

The matching module 13 is used for checking whether the CPE 100 stores a language environment the same as the language version of the browser 201 or not, and outputs a matching result to the setting module 14 when the language environment is the same as the language version of the browser 201. When the language version of the browser 201 is different from any language environment stored in the CPE 100, the matching module 13 sends a reminder message that there is no appropriate language environment that can be used by the electronic device 200.

The setting module 14 is used for making the language environment of the CPE 100 the same as the language version of the browser 201 and listing the selective configuration parameters corresponding to the language version of the browser 201, upon the matching result of the matching module 13. Generally, the manufacturers may pre-store configuration parameters, such as WIFI-channel options and wimax frequencies, in the CPE 100. For different countries, the configuration parameters are different. Before the CPE 100 is shipped from the factory, the manufacturers select a configuration parameter corresponding to the marketing country. In the present embodiment, after changing the language environment, the setting module 14 also changes the configuration parameters of the CPE 100 corresponding to the current language environment. In addition, lists the configuration parameters corresponding to the current language environment and the user can find and choose the correct configuration parameter corresponding to the current language environment quickly. For example, when the setting module 14 sets the language environment of the CPE 100 as United States English version, it then refreshes the configuration web page of the CPE 100 to show the configuration web page in English. Then the setting module 14 reloads the configuration parameters corresponding to the United States and shows an options list to the user.

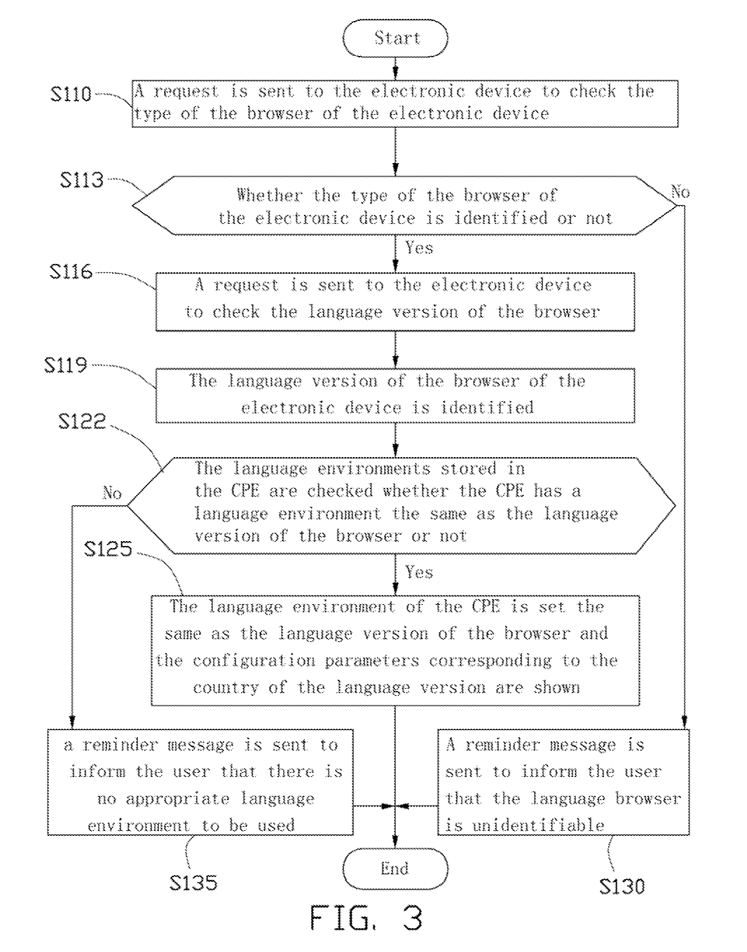

Referring to FIG. 3, a configuration method of the CPE 100 includes the following steps.

Step S110, a request is sent to the electronic device 200 to check the type of browser 201 of the electronic device 200. As different types of browsers 201 have different special functions, in the present embodiment, the identifying module 11 sends a request to the electronic device 200 to check the return value of the special functions corresponding to the browser 201 with JavaScript language.

Step S113, whether the type of the browser 201 of the electronic device 200 is identified or not. In the present embodiment, the identifying module 11 identifies the type of browser 201 according to the return value of the special functions. If the identifying module 11 is incapable of identifying the type of browser 201, then the CPE 100 performs step S130

Step S116, a request is sent to the electronic device 200 to check the language version of the browser 201. In the present embodiment, the language module 12 sends a request to the electronic device 200 for checking the language version of the browser 201 basing on the type of browser 201.

Step S119, the language version of the browser 201 of the electronic device 200 is identified. In the present embodiment, the language module 12 identifies the language version of the browser 201 by checking the language code of the browser 201.

Step S122, the language environments stored in the CPE 100 are checked whether the CPE 100 has a language environment the same as the language version of the browser 201 or not. In the present embodiment, the matching module 13 compares the language version of the browser 201 checked by the language module 12 with the language environments corresponding to different countries stored in the CPE 100, and outputs the matching result to the setting module 14. If the matching module 13 can not find a language environment of the CPE 100 the same as the language of the browser 201, then the CPE 100 performs step S135.

Step S125, the language environment of the CPE 100 is set the same as the language version of the browser 201 and the configuration parameters corresponding to the country of the language version are shown. In the present embodiment, the setting module 14 makes the language environment of the CPE 100 same as the language version of the browser 201 to allows the user to be able to read it easily, when the matching module 13 checks that the CPE 100 stores a language environment matching the language of the browser 201. The setting module 14 also lists the configuration parameters corresponding to the country of the language version to allow the user find the corresponding configuration quickly, when the matching module 13 checks that the CPE 100 stores a language environment matching the language of the browser 201.

Step S130, a reminder message is sent to inform the user that the language browser is unidentifiable. In the present embodiment, if the identifying module 11 is incapable of identifying the type of browser 201, the identifying module 11 will send a reminder message to the electronic device 200 to inform the user that the CPE 100 is incapable of identifying the browser 201.

Step S135, a reminder message is sent to inform the user that there is no appropriate language environment that can be used. In the present embodiment, if the language version of the browser 201 is different from any language environment stored in the CPE 100, the matching module 13 sends a reminder message that there is no appropriate language environment to the electronic device 200.

While certain embodiments have been described and exemplified above, various other embodiments will be apparent to those skilled in the art from the foregoing disclosure. The present disclosure is not limited to the particular embodiments described and exemplified, and the embodiments are capable of considerable variation and modification without departure from the scope of the appended claims.

What is claimed is:

1. A customer premises equipment accessible with electronic device having a browser and pre-stored with multiple language environments for different countries, comprising:
a language module configured for recognizing a language version of the browser;
a matching module configured for checking whether the customer premises equipment stores a language environment the same as the language version of the browser or not; and
a setting module configured for making the language environment of the customer premises equipment the same as the language version of the browser, when the matching module determines that the customer premises equipment stores a language environment matching the language version of the browser.

2. The customer premises equipment as claimed in claim 1, further comprising an identifying module configured for identifying a type of browser of the electronic device.

3. The customer premises equipment as claimed in claim 1, wherein the customer premises equipment pre-stores multiple configurations corresponding to different countries of the multiple language environments.

4. The customer premises equipment as claimed in claim 3, wherein the setting module is configured for listing the selective configuration parameters corresponding to the country of the language version of the browser.

5. The customer premises equipment as claimed in claim 1, wherein the customer premises equipment is one selected from the group consisting of a router and a network switch.

6. The customer premises equipment as claimed in claim 1, wherein the electronic device is one selected from the group consisting of a workstation and a personal computer.

7. The customer premises equipment as claimed in claim 1, wherein the customer premises equipment communicates with the electronic device with a cable.

8. The customer premises equipment as claimed in claim 1, wherein the configuration parameters are WIFI-channel options corresponding to different countries.

9. A configuration method for setting a language environment of a customer premises equipment with multiple language environments the same as the language version of a browser of a electronic device connected with the customer premises equipment, and comprising:
identifying the language version of the browser of the electronic device;
checking whether a language environment stored in the customer premises equipment the same as the language version of the browser or not; and
setting the language environment of the customer premises equipment same as the language version of the browser.

10. The method as claimed in claim 9, wherein the configuration method further comprises: identifying the type of browser.

11. The method as claimed in claim 9, wherein the customer premises equipment pre-stores multiple configurations corresponding to different countries of the multiple language environments, the step of the setting the language environment of the customer premises equipment the same as the language version of the browser further comprises: listing the optional configuration parameters corresponding to the country of the language version of the browser.
